(19) United States
(12) Patent Application Publication
(10) Pub. No.: US 2009/0109560 A1
(43) Pub. Date: Apr. 30, 2009

(54) POLYIMIDE DEFORMABLE MIRROR

(76) Inventor: John Farah, Attleboro, MS (US)

Correspondence Address: John Farah, Building 3, Apt. 2, 60 Phillips Street, Attleboro, MA, 02703, US

(21) Appl. No.: 11/866,762

(22) Filed: Oct. 3, 2007

Related U.S. Application Data
(63) Continuation of application No. 11/330,784, filed on Jan. 12, 2006, now abandoned.
(60) Provisional application No. 60/643,334, filed on Jan. 12, 2005.

(51) Int. Cl. G02B 7/188; B29D 11/00

(52) U.S. Cl. 359/847; 264/1.9

(57) ABSTRACT

This invention concerns the fabrication of deformable mirrors that can be used for adaptive optics applications to correct wavefront aberrations. The deformable mirror uses a polyimide substrate with a PZT layer, which is cut by laser to produce a structure with a free end attached to the polyimide substrate at one corner. The deformable mirror has an aperture less than 10 cm and is cost-effective to produce. The deformable mirror is driven piezoelectrically as a bimorph or monomorph and can achieve a stroke of 15 microns and a bandwidth of 1 kHz for less than 20 volts. The deformable mirror uses a continuous sheet, which is anchored at only one point, which corresponds to the point of arbitrary zero phase, and is free everywhere else to conform to the wavefront. This cannot be achieved with silicon micromachined mirrors, which are electrostatically actuated because surface micromachining produces delicate films which must be anchored periodically for support.

### RELATED APPLICATIONS

This application is a continuation under 35 U.S.C. § 120 of U.S. patent application Ser. No. 11/330,784, entitled Polyimide Deformable Mirror,” filed on Jan. 12, 2006, which claims priority under 35 U.S.C. § 119(e) to U.S. Provisional Application Ser. No. 60/643,334, entitled “Polyimide Deformable Mirror,” filed on Jan. 12, 2005, each of which is herein incorporated by reference in its entirety.

### SUMMARY OF INVENTION

This invention concerns the fabrication of deformable mirrors that can be used in adaptive optics applications.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an AO deformable mirror;

FIG. 2 illustrates a cross-section of a deformable mirror.

### BACKGROUND

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Deformable mirrors are used in adaptive optic systems to correct wavefront aberrations due to atmospheric propagation. Most deformable mirrors currently in use are large on the order of one meter diameter or even larger and are made of thin glass sheets with a reflective coating driven from the backside with discrete piezoelectric, electrostrictive or electromagnetic actuators. The spacing between actuators is typically on the order of a few millimeters. The technology for building large deformable mirrors. It is desired to reduce the cost of adaptive optic systems by using small scale deformable mirrors, which are on the order of 10 cm or less. It is expected that micro-electro-mechanical (MEMS) fabrication technology could yield the desired cost reduction.

Performance Requirements

The performance requirements on the next generation deformable mirrors for atmospheric correction applications are a stroke upward of 15 microns and mechanical and system bandwidths of at least 1 kHz and spatial arrays of at least 100×100 elements. Such a system would have the necessary dynamic range, bandwidth and resolution to correct large, dynamic and high spatial frequency aberrations. This would require driving voltages of several hundred volts using discrete actuators. It is desired to lower the driving voltages and power consumption of control systems and to reduce the size of the whole system. The cross section of the optical beam in a telescope or imaging system can be scaled down to an aperture of about 1 cm², which makes it compatible with MEMS fabrication. An array of about 100×100 MEMS actuators 100 μm each would yield adequate spatial resolution to correct most atmospheric wavefront aberrations. The MEMS array can be scaled up by a factor of 10 to a size of about 10 cm. Current state of the art silicon MEMS arrays are 32×32 with a spacing of about 300 microns between mirrors. It is also desired that the mirror surface be smooth in order to reduce scattering. The surface roughness of current micromirrors is about 30 nanometers rms.

Continuous Sheet Deformable Mirror

The ideal adaptive optic deformable mirror is a continuous sheet with sufficient spatial resolution and dynamic agility, which warps and conforms perfectly to the wrinkled wavefront. The mirror need only acquire one half the curvature of the wavefront when used in reflection. The mirror need not be made of discrete actuators because the wavefront itself is not discrete. The wavefront is a continuous surface. The mirror can be continuous as long as it has sufficient spatial resolution to follow the spatial frequencies of the wavefront and that it can be reconfigured sufficiently quickly to follow the variations of the wavefront in real time. Furthermore, the mirror must be anchored at only one point, which corresponds to the point of arbitrary zero phase, and must be free everywhere else across the entire sheet to follow the undulations of the wavefront. This goal cannot be achieved easily using silicon micromachining in conjunction with electrostatic actuation because surface micromachining produces delicate films which must be anchored periodically for support. Furthermore, electrostatic actuation cannot produce the large strokes required. Silicon microstructures can be fabricated using expensive bulk micromachining technologies such as deep reactive ion etching but then again it is difficult to achieve the large strokes because a bulk silicon microstructure is too stiff to actuate by micro-electro-mechanical means at reasonable voltages.

Surface Micromachined Silcion Structures

A typical surface micromachined silicon structure consists of a very thin polysilicon film carrying an electrode across an air gap a couple of microns away from the stationary electrode on the silicon wafer. The air gap is formed by selectively etching a sacrificial layer, such as BSG. A voltage applied between the two electrodes causes the cantilevered electrode to displace about 0.6 micron for cantilevers that are on the order of 100 microns long. The dependence of voltage on displacement is non-linear and the electrostatic force diminishes rapidly for large displacements. In order to simulate the displacement of the continuous sheet and provide piston as well as tip/tilt motion each micromirror in the array is suspended at each corner by a cantilever beam driven electrostatically. The cantilevers are made thin and patterned parallel to the sides of the square mirror in order to increase the fill factor. Discrete actuators can only approximate a curved surface at best. In order to improve the approximation the number of actuators is increased. Another problem with surface micromachined structures is that the addition of extra polysilicon and oxide layers to provide vertical connectivity cause excessive stresses and wafer warpage, which affect the accuracy of subsequent lithography steps. A significant effort is directed toward managing and mitigating the stresses in multi-layered surface machined structures. Emerging MEMS device requirements in fields like adaptive optics and tunable RF applications are beginning to exceed the capabilities of even the most sophisticated surface micromachining technologies. The mirror flatness and surface quality problems associated with stress in surface machined devices are so severe that it is contemplated to fabricate micro-mirror arrays from stress-free single crystal silicon to ensure optically flat surfaces.

Optical MEMS Designs

There are three distinctinct applications for optical MEMS:
1) beam steering for display, maskless lithography, switching, routing (tip/tilt)
2) Spatial Light Modulators (piston)
3) wavefront correction

These three functionalities can be implemented by three different designs of the MEMS element and actuation mechanism. The beam steering application requires tip/tilt motion of the mirror. A typical device is a hinged micro-mirror, which is pulled electrostatically to one side or the other. The cross section of a beam is divided into sub-apertures or pixels, which are tilted individually in a digital (on/off) fashion, such as the digital light processor (DLP) or for channel dropping in telecom networks; or analog to connect to different destinations. Spatial light modulators consist of arrays of pixels, which modulate the phase of a beam individually through piston motion of the micro-mirrors. SLMs are usually implemented either with liquid crystals or MEMS. LCs are too slow and cannot provide the dynamic bandwidth necessary for atmospheric corrections. Typical MEMS SLMs are periodically anchored membrane arrays, which are actuated electrostatically and move in piston mode. Usually, SLMs are not capable of providing tip/tilt. However, a membrane can be attached to the MEMS SLM to provide a continuous sheet. The larger the number of actuators, the better is the approximation. The third application, wavefront correction or adaptive optics, is distinct from the first two in that no discrete actuators are required. It is best implemented by a continuous sheet, which wraps itself around the wavefront that it is supposed to unravel. The requirements on such a sheet are that it must have sufficient spatial resolution and dynamic agility to follow the variations of the wavefront in real time and space.

Segmented Electrodes

The goal of the wavefront correction functionality is to match the wavefront as much as possible. Matching a curve perfectly entails matching the displacement, the slope, the curvature and every higher order derivative at every point along the curve. SLMs attempt to correct a wavefront by matching the displacement at a discrete set of periodically spaced points. This does not guarantee that the slope, the curvature and the higher order derivatives are matched. SLMs can better approximate the actual wavefront by increasing the number of actuators in the MEMS array. A continuous sheet must utilize segmented electrodes to provide the desired spatial resolution.

Bimorph Actuator

One type of continuous sheet deformable mirror is the bimorph, which is made by the superposition of a piezoelectric sheet with another material or joining of two piezoelectric sheets of opposite polarity. These sheets are supported as membranes with diameters on the order of a few centimeters. A distinctive feature of the bimorph actuator is that the driving force is applied in the plane of the sheet, as opposed to the electrostatic force, which is applied perpendicular to the surface of the mirror. A consequence of this distinction is that the normal force yields a displacement, whereas the planar force yields a curvature of the continuous sheet at the point of application of the force. Bimorph actuated mirrors have the advantage of simpler control systems, especially when the drive signal is proportional to the curvature of the wavefront. Furthermore, bimorph requires a fewer number of actuators to fit a certain curve compared to linear actuators.

### DETAILED DESCRIPTION

Free End Structures

An important measure of the performance of a DM is its dynamic range, which is associated with large strokes necessary to compensate for atmospheric turbulence. In continuous sheet bimorph mirrors the displacement at any point is a function of the displacements at other points on the mirror, i.e. influence function. By contrast, in SLMs and discrete actuators the displacement at a particular point depends only on the force applied at that point. The influence function also depends on the type of support whether the structure is clamped or free-end. The largest influence functions are obtained near the free end. A force applied near the clamped end of a cantilever, for example, induces a large displacement near the free end. Thus, a free-end structure is capable of large strokes away from the clamped end with modest applied voltages even though each individual actuator by itself may not have a wide dynamic range. The use of a free-end continuous sheet obviates the need for a wide dynamic range to obtain a large stroke.

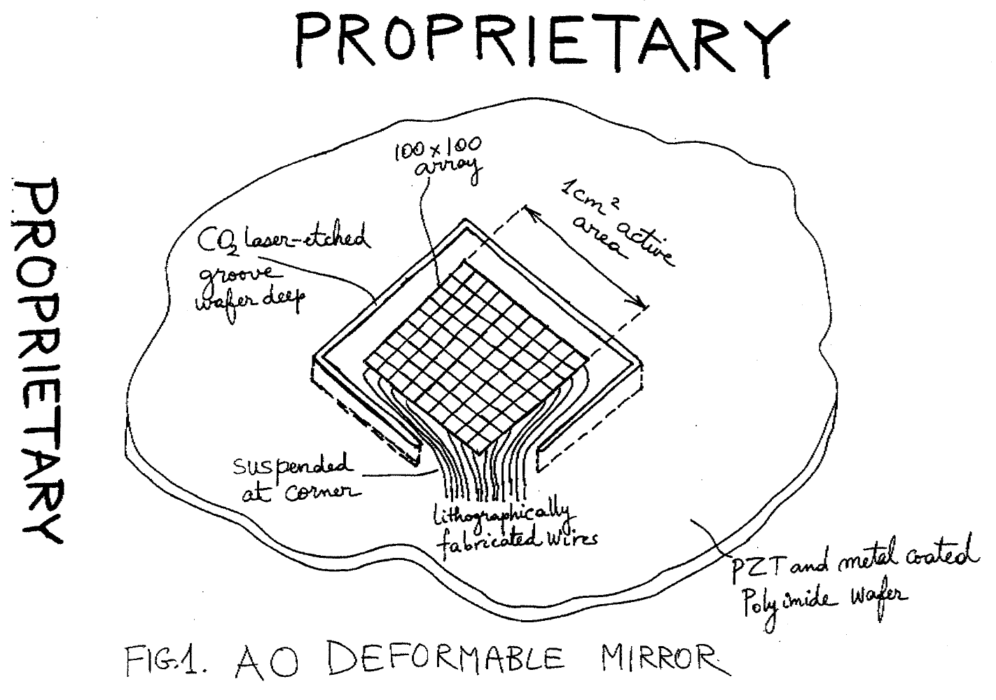

The most advantageous deformable mirror for adaptive optic applications is a continuous sheet with a free end driven in bimorph mode because it can achieve the largest displacements at reasonable voltages. The mirror is preferably anchored at only one point across its surface corresponding to the point of arbitrary zero phase. It must be free everywhere else to conform to the wavefront. This implies that the mirror should rather be supported as a cantilever than a membrane. The mirror could be square, rectangular or circular, which is clamped at only one corner or at one point on the circumference but free everywhere else along the perimeter, as shown in FIG. 1.

Fabrication of Deformable Mirror

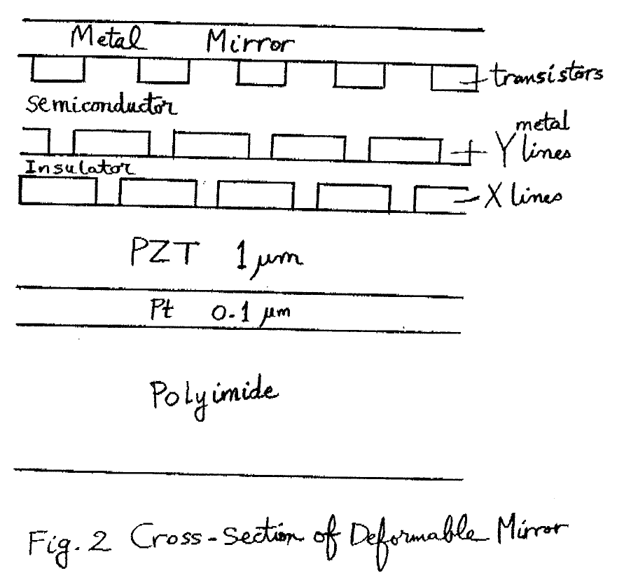

The deformable mirror is fabricated by depositing a PZT film on a polyimide wafer. A thin layer of platinum about 0.1 □m thick is first deposited on the polyimide wafer by sputtering or evaporation, which serves as the ground electrode. A piezoelectric PZT film, about one micron thick, is deposited using either Chemical (CVD) or Physical (PVD) Vapor Deposition and annealed using either rapid thermal annealing or laser radiation to produce the perovskite crystalline structure, which exhibits good piezoelectric properties. The temperature of the polyimide substrate does not exceed the thermal limit of the polyimide material during the PZT deposition and annealing. The PZT film can also be deposited using the solgel technique. Subsequently, two metallic films, such as Pt or aluminum or any other suitable metal, are deposited on top of the PZT film and separated by an insulating layer, such as polymeric layer. The metallic films are patterned in the form of an X-Y grid using optical or e-beam lithography and etching, and serve as the upper electrode. The lines are about 100 μm wide and separated by narrow gaps sufficient to isolate them electrically and reduce cross talk among adjacent electrodes. The lines can be wider or narrower. Features as narrow as 2 μm lines and spaces have been fabricated phtolithographically on the polyimide wafers. A grid of 100×100 lines is fabricated containing an array of 10,000 actuators. Such an array yields adequate spatial resolution. Smaller and larger arrays are also fabricated. Subsequently, a semiconducting film, which could be organic such as Pentacene, is deposited over the lines and used to make transistors over each actuator for addressing the individual PZT pixels. The pixels are addressed sequentially in an active matrix format similar to displays by holding the voltage constant on a horizontal line while scanning the vertical lines and vice versa. This format simplifies the multiplexing architecture and allows addressing the 10,000 actuators with only 200 wires. Finally, a metallic film, such as gold or any other suitable metal is deposited on top of the organic film to form a continuous mirror. The mirror has an area of about 1 cm². Smaller and larger mirrors are also fabricated. A cross-section of the structure is shown in FIG. 2.

Corner Design

The corner where the floating mirror is attached to the wafer is not just a single point. It provides space for the X-Y grid lines to connect to wires on the wafer mainland. The interconnects are fabricated lithographically. The corner region is widened to accommodate all the interconnects. The plate is made larger than the actual size of the mirror. The mirror occupies the central zone of the plate. The mirror is fabricated by scribing a line along the contour of a square plate while leaving it hanging from one corner. The wafer is scanned under a focused CO₂ or YAG laser. The ablation machine is programmed to yield the desired contour automatically. Several such mirrors can be fabricated in one wafer in a matter of minutes in an ordinary shop environment. Fabrication of the mirror does not necessitate the use of clean room laboratories or silicon MEMS foundry. The use of polyimide wafer makes cost-effective and easy bulk micromachining possible for deformable mirrors.

Polyimide Wafer

U.S. Pat. No. 6,807,328 covers the polyimide wafer.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A deformable mirror comprising:
a substrate;
a first metallic layer deposited on said substrate;
a piezoelectric layer deposited on said first metallic layer;
a second metallic layer deposited on said piezoelectric layer;
said substrate, said first metallic layer, said piezoelectric layer and said second metallic layer being cut to form a structure with a fixed end and a free end, said fixed end being attached to said substrate at a periphery of said structure.

2. The deformable mirror of claim 1 wherein a majority of said structure is free.

3. The deformable mirror of claim 2 wherein said fixed end is a corner of said structure.

4. The deformable mirror of claim 2 wherein said fixed end is on the circumference of said structure.

5. The deformable mirror of claim 1 wherein said first metallic layer is platinum.

6. The deformable mirror of claim 5 wherein said piezoelectric layer is PZT.

7. The deformable mirror of claim 1 wherein said structure is a monomorph.

8. The deformable mirror of claim 1 wherein said structure is a bimorph.

9. The deformable mirror of claim 1 wherein metal lines carrying signals cross said fixed end from said substrate to said structure.

10. The deformable mirror of claim 1 wherein said substrate is polyimide.

11. The deformable mirror of claim 10 wherein said substrate, said first metallic layer, said piezoelectric layer and said second metallic layer are cut with a laser.

12. A method of fabricating a deformable mirror comprising:
providing a substrate;
coating said substrate with a first metallic layer;
depositing a piezoelectric layer on said first metallic layer;
depositing a second metallic layer on said piezoelectric layer;
cutting said substrate, said first metallic layer, said piezoelectric layer and said second metallic layer to form a structure with a fixed end and a free end, said fixed end being attached to said substrate at a periphery of said structure.

13. The method of claim 12 wherein a majority of said structure is free.

14. The method of claim 13 wherein said fixed end is a corner of said structure.

15. The method of claim 13 wherein said fixed end is on the circumference of said structure.

16. The method of claim 12 wherein said first metallic layer is platinum.

17. The method of claim 16 wherein said piezoelectric layer is PZT.

18. The method of claim 12 wherein said substrate is polyimide.

19. The method of claim 18 wherein said cutting step is done with a laser.

20. The method of claim 12 wherein said cutting step is done with deep reactive ion etching.
